(19) United States
(12) Patent Application Publication
(10) Pub. No.: US 2020/0307737 A1
(43) Pub. Date: Oct. 1, 2020

(54) Foldable Vehicle

(71) Applicant: Smacircle Technology (Shenzhen) Co., Ltd., Shenzhen (CN)

(72) Inventor: Luyao Zhuang, Shenzhen (CN)

(73) Assignee: Smacircle Technology (Shenzhen) Co., Ltd., Shenzhen (CN)

(21) Appl. No.: 16/305,521

(22) PCT Filed: May 24, 2017
(86) PCT No.: PCT/CN2017/085685

§ 371 Date: Nov. 29, 2018

(30) Foreign Application Priority Data
May 31, 2016 (CN) 201610377341.X
May 31, 2016 (CN) 201620517291.6

(51) Int. Cl. B62K 15/00; B62K 21/02; B62K 21/22; B62K 21/26; B62K 21/12; B62J 1/08

(52) U.S. Cl. CPC B62K 15/006; B62K 21/02; B62K 21/22; B62K 2015/003; B62K 21/12; B62J 1/08; B62K 21/26

(57) ABSTRACT

A folding vehicle has a frame body which has a front split ring (1) and a rear split ring (2) connected by a folding mechanism (3), and the front split ring (1) and the rear split ring (2) form a closed loop body after folding, thereby reducing the space occupied by the folding vehicle, and at the same time reducing the material consumption, significantly reducing the vehicle weight, and improving the portability.

### BACKGROUND OF THE INVENTION

### 1. Field of the Invention

The present invention relates to the technical field of the production of micro-scooters, and in particular, to a folding bicycle.

### 2. Description of the Prior Art

As living standards improve, people's lives have increasingly diverse needs, so folding vehicles that are suitable for urban short-distance travel and which are easy to carry are more and more becoming the choice of consumers.

Under normal circumstances, a folding vehicle is suitable for being placed in a bag or the trunk of a car after it has been folded, so the objective is to provide a lightweight and small folding vehicle.

FIG. 1 illustrates a relatively lightweight folding vehicle that currently exists. The frame body is formed by two mutually hinged annular members 01, and the front and rear wheels are respectively arranged on the front and rear of the two annular members 01. When folding, the front and rear annular members 01 of the frame body are fitted to each other after rotating around the hinge portion between them, and the front and rear wheels are respectively embedded in the two rings formed inside the annular members 01. Although the folding electric vehicle can be conveniently folded, since the frame is folded to form two mutually fitting annular members 01, the material and structure of the frame main body are still not sufficiently simplified, so that the weight of the current folding electric vehicle will still be maintained at around 15 kg-20 kg, and the overall size in the thickness direction is also large. Therefore, it is still not very convenient to carry, especially in a carrying case such as a backpack.

Therefore, how to further reduce the weight of the folding vehicle and the volume occupied by the folded vehicle in order to further improve the portability of the folding vehicle is a technical problem that the technical personnel in the field need to solve.

### SUMMARY OF THE INVENTION

It is an object of the present invention to provide a folding vehicle so as to further reduce the weight of the folding vehicle and the volume occupied after folding to further improve the portability of the folding vehicle.

To achieve the above object, a folding vehicle disclosed by the present invention includes a frame body including a front split ring and a rear split ring connected by a folding mechanism, and after folding, the front split ring and the rear split ring forms a closed loop.

Preferably, the folding mechanism is a pull-type telescopic section with a locking device, the front split ring is connected to a front end of the pull-type telescopic section, the rear split ring is connected to a rear end of the pull-type telescopic section.

Preferably, the pull-type telescopic section is one set, the front end of the pull-type telescopic section is connected to an upper interface of the front split ring, and the rear end is connected to an upper interface of the rear split ring. Alternatively, the front end of the pull-type telescopic section is connected to a lower interface of the front split ring, and the rear end is connected to a lower interface of the rear split ring.

Preferably, the pull-type telescopic section includes an upper telescopic joint and a lower telescopic joint, wherein the front end of the upper telescopic joint is connected to an upper interface of the front split ring, and the rear end of the upper telescopic joint is connected to an upper interface of the rear split ring; the front end of the lower telescopic joint is connected to the lower interface of the front split ring, and the rear end is connected to the lower interface of the rear split ring.

Preferably, the bottom end of the front split ring is hinged with the bottom end of the rear split ring to form the folding mechanism, and the hinge position is further provided with a locking device; the upper end of the front split ring and the upper end of the rear split ring are free ends.

Preferably, the upper end of the front split ring is hinged with the upper end of the rear split ring to form the folding mechanism, and the hinge position is further provided with a locking device, and the bottom end of the front split ring and the bottom end of the rear split ring are free ends.

Preferably, the lower part of the front split ring is a rotatable front fork, the front wheel is reversibly disposed on the front fork, and the rear wheel is reversibly disposed on the rear split ring, and after folding, the front wheel is turned over to one side of the closed loop body and embedded in the closed loop body, the rear wheel is turned over to the other side of the closed loop body and embedded in the closed loop body.

Preferably, a handlebar assembly extends from an upper portion of the front split ring and is coupled to the front fork, the handlebar assembly including a handlebar riser and a grip disposed at a top end of the handlebar riser, and the riser is a telescopic tube with a locking device.

Preferably, the outer end of the grip is bendable toward the inner side of the folding vehicle, and after folding, the grip forms a handle for the user to lift the folding vehicle.

Preferably, the upper part of the rear split ring is further provided with a seat assembly, the seat assembly comprising a seat riser and a seat disposed at a top end of the seat riser, the seat riser having a locking device.

Preferably, the outer end of the grip can be bent toward the inner side of the folding vehicle, and after folding, the grip forms a handle for the user to lift the folding vehicle.

Preferably, the upper part of the rear split ring is further provided with a seat assembly, and the seat assembly comprises a seat riser and a seat disposed at the top end of the seat riser, and the seat riser is a stretch tube with a locking device.

Preferably, a folding foot pedal is disposed on the front split ring or the rear split ring and is embedded in the closed loop body after folding.

Preferably, the front split ring and the rear split ring are both semi-circular rings.

It can be seen from the above technical solution that the folding vehicle disclosed in the present invention includes a frame main body, and the frame main body includes a front split ring and a rear split ring connected by a folding mechanism, and after folding, the front split ring and the rear split ring form a closed loop body.

Since the body of the frame is composed of two split rings, the two split rings will form a closed loop body after folding, and the folding vehicle has only one closed loop after folding, which is effective compared to the prior art. The space occupied by the folding vehicle is reduced, and the weight of the whole vehicle is also significantly reduced due to the reduction of the material used, which greatly improves the portability of the folding vehicle.

### BRIEF DESCRIPTION OF THE DRAWINGS

FIG. 1 is a schematic diagram of a folding vehicle according to the prior art.

FIG. 2 is a schematic view showing the structure of a folding vehicle according to one embodiment of the present invention.

FIG. 3 is a schematic view showing the structure of the folding vehicle of FIG. 2 after folding.

FIG. 4 is a schematic view showing the structure of a folding vehicle according to another embodiment of the present invention.

FIG. 5 is a schematic view showing the structure of a folding vehicle according to yet another embodiment of the present invention.

FIG. 6 is a schematic view showing the structure of a folding vehicle according to still another embodiment of the present invention.

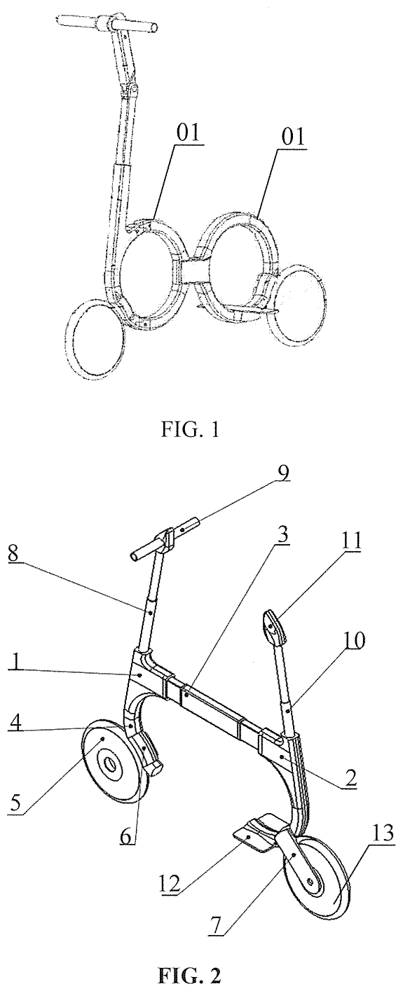

Wherein, 1 is a front split ring, 2 is a rear split ring, 3 is a folding mechanism, 4 is a front fork, 5 is a front wheel, 6 is a front wheel frame, 7 is a rear wheel frame, 8 is a handlebar riser, 9 is a grip, 10 is a seat riser, 11 is a seat, 12 is a folding pedal, and 13 is a rear wheel.

### DETAILED DESCRIPTION OF THE PREFERRED EMBODIMENTS

The main objective of the present invention is to provide a folding vehicle that can further reduce the weight of the folding vehicle and the volume occupied by the folded vehicle to further improve the portability of the folding vehicle.

In order to enable the person skilled in the art to better understand the principles of the present invention, the present invention will be further described in detail below in conjunction with the drawings and specific embodiments.

The folding vehicle disclosed in the present invention actually includes, but is not limited to, an electric bicycle, a bicycle, a scooter, etc., and the folding vehicle includes a frame main body including a front split ring 1 and a rear split ring 2 connected by a folding mechanism 3. The front split ring 1 and the rear split ring 2 form a closed loop after folding.

In the above embodiment, since the frame body is formed by two split rings, the two split rings will form a closed loop after folding, and the folding vehicle will only form one closed loop after folding compared to the prior art, thus it effectively reduces the space occupied by the folding vehicle, and at the same time, the vehicle's weight is also significantly reduced due to the reduction of the material used, which greatly improves the portability of the folding vehicle.

It is understood by those skilled in the art that the implementation of the folding mechanism 3 is not limited to one specific embodiment. For example, in the embodiment of the present invention, the folding mechanism 3 is a pull-type telescopic section with a locking device, and the front split ring 1 is connected to the front end of the pull-type telescopic section, the rear split ring 2 is connected to the rear end of the pull-type telescopic section, and the locking device can be any well-known locking device, such as a positioning pin, a bead, and the like. It should be noted that in the present embodiment, the direction in which the folding vehicle travels is forward, and thus the pull-type telescopic section has front and rear ends, and the front split ring 1 and the rear split ring 2 are also named for these directions.

In a specific embodiment, as shown in FIG. 2, the pull-type telescopic section specifically includes one set, the front end of the pull-type telescopic section is connected with the upper interface of the front split ring 1, and the rear end of the pull-type telescopic section is connected with the upper interface of the rear split ring 2. The pull-type telescopic section includes at least three segments having different cross sections, each of which can be retracted into an adjacent larger section to shorten the overall length. The bottoms of the front split ring 1 and the rear split ring 2 also meet to form a closed loop when the pull-type telescopic section is fully retracted. Furthermore, the adjacent two segments in the pull-type telescopic section can be connected by rollers, bearings or sliders for smooth pulling action. After the telescopic position is reached, the locking device will lock the telescopic joint to prevent rotation and looseness of the pull-type telescopic section.

It should be noted that, in the above embodiment, since one split ring has two end portions, the upper end portion is referred to as an upper interface, and the lower portion is referred to as a lower interface.

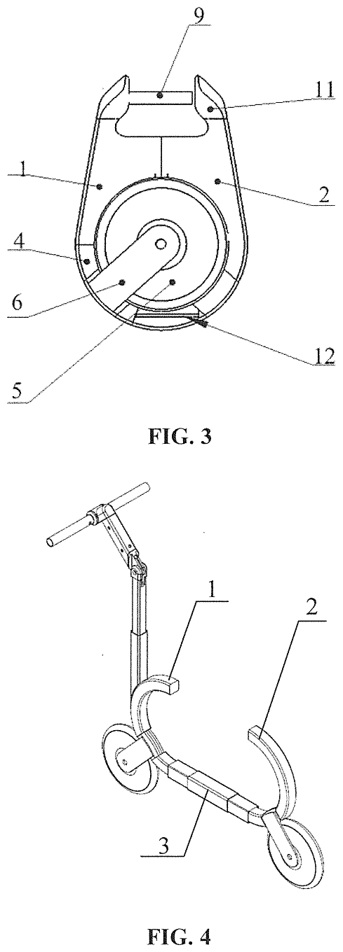

The lower part of the front split ring 1 is a rotatable front fork 4, as shown in FIG. 2, the front wheel 5 is reversibly disposed on the front fork 4 by the front wheel frame 6, and the rear wheel 13 is reversibly disposed on the rear split ring 2 by the rear wheel frame 7. After folding, the front wheel 5 is turned over to one side of the closed loop body and embedded in the closed loop body, and the rear wheel 13 is turned over to the other side of the closed loop body and embedded in the closed loop body, as shown in FIG. 3. Of course, the front wheel 5 and the rear wheel 13 should be provided with a locking device that provides a locking action after the front and rear wheels are unfolded or folded to prevent the front and rear wheels from becoming loose.

The upper part of the front split ring 1 extends into the handlebar assembly, the bottom end of the handlebar assembly is connected to the front fork 4, and the handlebar assembly and the front split ring 1 are connected with each other through parts such as headsets, and bearings. The structure used for these connections can be the same as those used for conventional bicycle frames, and is not further described herein. The handlebar assembly includes a handlebar riser 8 and a grip 9 disposed at the top end of the handlebar riser 8, as shown in FIG. 2, and the handlebar riser 8 is a telescopic tube with a locking device. The locking device on the handlebar riser 8 is preferably a positioning pin or a top bead. Of course, it can also be a screw or a quick release wrench.

Compared with the prior art, in the above embodiment of the folding vehicle, it only needs to drive the front fork 4 to rotate when the steering is performed, without driving the entire front split ring 1 to rotate, thereby making the steering of the vehicle lighter and less labor-intensive, which improves customer comfort.

Further, the outer end of the grip 9 can also be bent toward the inner side of the folding vehicle, and after bending, it is parallel with the plane of the closed loop body. After folding, the grip 9 forms a handle for the user to lift the folding vehicle as shown in FIG. 3.

In addition, with a view towards comfort, a seat assembly can also be provided at the upper portion of the rear split ring 2, as shown in FIG. 2. The seat assembly includes a seat riser 10 and a seat 11 is provided at the top portion of the seat riser 10. The seat riser 10 can also be comprised of a telescopic tube with a locking device. The locking device of the seat riser 10 is preferably a positioning pin, a bead, a screw or a quick release wrench. As shown in FIG. 3, the seat riser 10 and the seat 11 are also hidden after folding, thereby effectively reducing the volume occupied by the folding vehicle.

Of course, after the seat is set, it is necessary to consider setting the foot pedal. For this reason, the folding vehicle disclosed in this embodiment further includes a folding foot pedal 12 disposed on the front split ring 1 or the rear split ring 2. As shown in FIG. 2, the folding foot pedal 12 can also be embedded in the closed loop after folding in order to maximize space savings.

In addition, when the pull-type telescopic section includes one set, the front end of the pull-type telescopic section can also be connected to the lower interface of the front split ring 1, and the rear end is connected to the lower interface of the rear split ring 2, as shown in FIG. 4. The pull-type telescopic section includes at least three segments having different cross sections, each of which can be retracted into an adjacent larger section to shorten the overall length. When the pull-type telescopic section is fully retracted, the tops of the front split ring 1 and the rear split ring 2 also meet to form a closed loop. Furthermore, the adjacent two segments in the pull-type telescopic section can be connected by rollers, bearings or sliders for smooth pulling action. After the telescopic position is reached, the locking device will lock the telescopic joint to prevent rotation and looseness of the pull-type telescopic section.

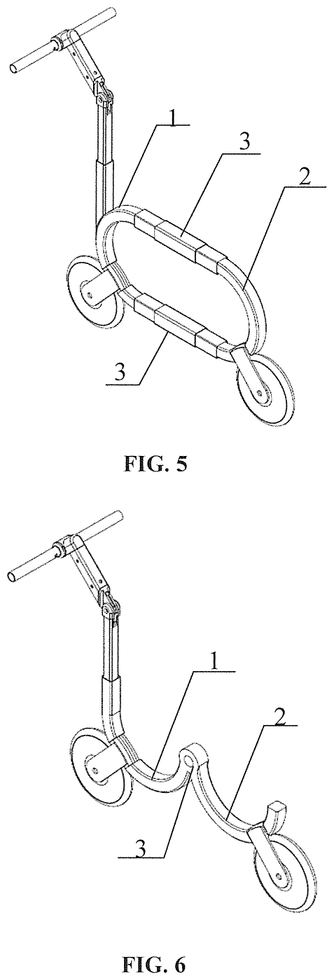

Of course, the pull-type telescopic section may further comprise two sets, with a pull-out section located at the upper part being referred to as an upper telescopic section, and a pull-out section located at the lower part being referred to as a lower telescopic section. The front end of the upper telescopic section is connected to the upper interface of the front split ring 1, and the rear end is connected to the upper interface of the rear split ring 2. The front end of the lower telescopic section is connected to the lower interface of the front split ring 1, and the rear end is connected to the lower interface of the rear split ring 2, as shown in FIG. 5. For the specific structure of the pull-type telescopic section in this embodiment, reference may be made to the structural design of the pull-type telescopic section in FIGS. 2 and 4.

It can be understood that the folding mechanism 3 can also be realized by means of a hinge joint. Referring to FIG. 6, in the present embodiment, the bottom end of the front split ring 1 is hinged with the bottom end of the rear split ring 2 to form a folding mechanism 3. A locking device is also provided at the hinge position, and the upper end of the front split ring 1 and the upper end of the rear split ring 2 are free ends. In this embodiment, the locking device is preferably a locating pin. It should be noted that, in the present embodiment, the bottom end of the front split ring 1 and the rear split ring 2 are referred to as the lower one of ends of the two split rings after the folding is completed.

Of course, a modification that is easily conceivable by those skilled in the art is that the folding mechanism 3 can also be formed after the upper end of the front split ring 1 is hinged with the upper end of the rear split ring 2, and the locking device should also be provided at the hinge position. The bottom end of the split ring 1 and the bottom end of the rear split ring 2 would both be free ends. In the present embodiment, the bottom end of the front split ring 1 and the bottom end of the rear split ring 2 are defined in the same manner as in the previous embodiment.

As shown in FIGS. 4 to 6, in order to be able to adjust the distance between the grip 9 and the human body, a handlebar adjustment mechanism may also be provided on the handlebar riser 8, which should include a grip mounting rod that is rotatable in a direction close to or away from the human body. The grip 9 is mounted on the grip mounting rod, and has a locking device for locking the grip mounting rod.

It is not difficult to understand that the shape of the closed loop body can be varied, such as elliptical, rectangular, polygonal, etc., the ring body can be called a closed loop body as long as it has a closed shape. Taking into account the volume occupied after folding and the beautiful aesthetic appearance after folding, the front split ring 1 and the rear split ring 2 in the embodiment of the present invention are both semi-circular rings, and the closed loop body after folding is a ring. The front wheel 5 and the rear wheel 13 are folded and can be embedded in the ring to minimize the space occupied by the folded vehicle and increase the aesthetics after folding.

The whole vehicle can be made of aluminum alloy, aluminum-bismuth alloy, steel, or carbon fiber. When a small part of the structure uses carbon fiber and most of the structure is made of aluminum alloy, if the folding vehicle disclosed in the present invention is made into an electric vehicle, when its maximum battery life is about 20 kilometers, its overall weight can be controlled at about 5 kg, and its folded volume is enough to ensure that it can be placed in the backpack and carried on the back, which greatly enhances the portability of the folding vehicle. The performance is extremely light, minimal and extremely beautiful.

The folding vehicle provided by the present invention has been described in detail above. The principles and embodiments of the present invention have been described herein with reference to specific examples, and the description of the above embodiments is only to assist in understanding the method of the present invention and its core idea. It should be noted that those skilled in the art can make various modifications and changes to the present invention without departing from the spirit and scope of the invention.

1. A folding vehicle comprising a frame body, wherein the frame body comprises a front split ring (1) and a rear split ring (2) connected by a folding mechanism (3), and after folding, the front split ring (1) and the rear split ring (2) form a closed loop.

2. The folding vehicle of claim 1, wherein the folding mechanism (3) is a pull-type telescopic section with a locking device, and the front split ring (1) is connected to the front end of the pull-type telescopic section, and the rear split ring (2) is connected to the rear end of the pull-type telescopic section.

3. The folding vehicle of claim 2, wherein the pull-type telescopic section is one set, the front end of the pull-type telescopic section is connected with an upper interface of the front split ring (1), and the rear end of the pull-type telescopic section is connected with an upper interface of the rear split ring (2); or
the front end of the pull-type telescopic section is connected to the lower interface of the front split ring (1), and the rear end of the pull-type telescopic section is connected to the lower interface of the rear split ring (2).

4. The folding vehicle of claim 2, wherein the pull-type telescopic section includes an upper telescopic joint and a lower telescopic joint, wherein a front end of the upper telescopic joint is connected to an upper interface of the front split ring (1), and a rear end is connected to an upper interface of the rear split ring (2); the front end of the lower telescopic joint is connected to the lower interface of the front split ring (1), and the rear end of the lower telescopic joint is connected to a lower interface of the rear split ring (2).

5. The folding vehicle of claim 1, wherein a bottom end of the front split ring (1) is hinged with a bottom end of the rear split ring (2) to form the folding mechanism (3), and a locking device is also provided at the hinge position, and the upper end of the front split ring (1) and an upper end of the rear split ring (2) are both free ends.

6. The folding vehicle of claim 1, wherein an upper end of the front split ring (1) is connected with an upper end of the rear split ring (2) to form the folding mechanism (3), and a locking device is further disposed at the hinge position, and wherein the bottom end of the front split ring (1) and the bottom end of the rear split ring (2) are both free ends.

7. The folding vehicle of claim 1, wherein a lower part of the front split ring (1) is a rotatable front fork (4), a front wheel (5) is reversibly disposed on the front fork (4), and a rear wheel (13) is foldably disposed on the rear split ring (2), and after folding, the front wheel (5) is turned over to one side of the closed loop body and embedded in the closed loop body, and the rear wheel (13) is flipped to the other side of the closed loop body and embedded in the closed loop body

8. The folding vehicle of claim 7, wherein a handlebar assembly extends from an upper portion of the front split ring (1) and is coupled to the front fork (4), the handlebar assembly including a handlebar riser (8) and a grip (9) at an upper end of the handlebar riser (8), and the handlebar riser (8) is a telescopic tube with a locking device.

9. The folding vehicle of claim 8, wherein an outer end of the grip (9) is bendable toward an inner side of the folding vehicle, and after folding, the grip (9) forms a handle for the user to lift the folding vehicle.

10. The folding vehicle of claim 8, wherein an upper part of the rear split ring (2) is further provided with a seat assembly, the seat assembly comprising a seat riser (10) and a seat (11) provided at a top end of the seat riser (10), wherein the seat riser (10) is a telescopic tube with a locking device.

11. The folding vehicle of claim 10, further comprising a folding foot pedal (12) disposed on the front split ring (1) or the rear split ring (2), the folding foot pedal (12) being embedded into the closed loop body after folding.

12. The folding vehicle of claim 1, wherein the front split ring (1) and the rear split ring (2) are both semi-circular rings.
